(19) United States
(12) Patent Application Publication
(10) Pub. No.: US 2016/0017204 A1
(43) Pub. Date: Jan. 21, 2016

(54) METHODS AND COMPOSITIONS COMPRISING PARTICLES FOR USE IN OIL AND/OR GAS WELLS

(71) Applicant: CESI Chemical, Inc., Houston, TX (US)

(72) Inventors: Randal M. Hill, The Woodlands, TX (US); David Germack, The Woodlands, TX (US); Melinda Soeung, Houston, TX (US); David L. Holcomb, Golden, CO (US)

(73) Assignee: CESI Chemical, Inc., Houston, TX (US)

(21) Appl. No.: 14/801,805

(22) Filed: Jul. 16, 2015

Related U.S. Application Data
(60) Provisional application No. 62/068,159, filed on Oct. 24, 2014.
(60) Provisional application No. 62/026,574, filed on Jul. 18, 2014.

(51) Int. Cl. C09K 8/36; C09K 8/584; C09K 8/60; E21B 43/16; C09K 8/42

(52) U.S. Cl. CPC C09K 8/36; E21B 43/16; C09K 8/42; C09K 8/602; C09K 8/584; C09K 2208/10

(57) ABSTRACT

Methods and compositions comprising particles for use in various aspects of the life cycle of an oil and/or gas well are provided.

### RELATED APPLICATIONS

This application claims priority to U.S. Provisional Application No. 62/026,574, filed Jul. 18, 2014 and U.S. Provisional Application No. 62/068,159, filed Oct. 24, 2014, which are incorporated herein by reference in their entirety.

### FIELD OF INVENTION

Methods and compositions comprising particles for the treatment of an oil and/or gas well are provided.

### BACKGROUND OF INVENTION

For many years, petroleum has been recovered from subterranean reservoirs through the use of drilled wells and production equipment. Oil and natural gas are found in, and produced from, porous and permeable subterranean formations, or reservoirs. The porosity and permeability of the formation determine its ability to store hydrocarbons, and the facility with which the hydrocarbons can be extracted from the formation.

When selecting or using a fluid to be utilized in the treatment of an oil and/or gas well, it is important for the fluid to comprise the right combination of additives and components to achieve the necessary characteristics of the specific end-use application. A primary goal amongst many aspects of well treatment is to optimize recovery of oil and/or gas from the reservoir. However, in part because the fluids utilized during the operation of an oil and/or gas well are often utilized to perform a number of tasks simultaneously, achieving necessary to optimal characteristics is not always easy.

Accordingly, improved methods and compositions are needed.

### SUMMARY OF INVENTION

Methods and compositions comprising particles (e.g., nanoparticles) for the treatment of an oil and/or gas well are provided.

In some embodiments, a method for treating an oil and/or gas well is provided comprising combining a first fluid and a second fluid to form an emulsion or microemulsion, wherein the first fluid comprises a plurality of hydrophobic nanoparticles and a non-aqueous phase, wherein the second fluid comprises a surfactant and an aqueous phase, and wherein in the microemulsion, a portion of the nanoparticles are each at least partially surrounded by surfactant and in contact with at least a portion of the non-aqueous phase; and injecting the emulsion or microemulsion into an oil and/or gas well comprising a wellbore.

Other aspects, embodiments, and features of the methods and compositions will become apparent from the following detailed description when considered in conjunction with the accompanying drawings. All patent applications and patents incorporated herein by reference are incorporated by reference in their entirety. In case of conflict, the present specification, including definitions, will control.

### BRIEF DESCRIPTION OF THE DRAWINGS

The accompanying drawings are not intended to be drawn to scale. For purposes of clarity, not every component may be labeled in every drawing. In the drawings:

FIGS. 1A-1C show schematic representations of non-limiting embodiments of emulsions or microemulsions comprising a particle.

FIG. 1D shows a schematic representation of a non-limiting emulsion or microemulsion comprising a plurality of particles, according to some embodiments.

FIG. 1E shows a schematic representation of a non-limiting bicontinuous microemulsion comprising a plurality of particles, according to certain embodiments.

### DETAILED DESCRIPTION

Methods and compositions for the treatment of an oil and/or gas well are provided. In some embodiments, the methods and compositions comprise an emulsion or a microemulsion. In some cases, the emulsion or microemulsion comprises an aqueous phase, a non-aqueous phase, and a plurality of particles (e.g., nanoparticles). In some embodiments, the particles are nanoparticles. In some embodiments, the particles (e.g., nanoparticles) are hydrophobic. In certain embodiments, each of at least a portion of the nanoparticles are at least partially encapsulated by surfactant and in contact with at least a portion of the non-aqueous phase. In some embodiments, the emulsion or microemulsion may be used in the method of treating an oil and/or gas well.

In some embodiments, methods for treating the oil and/or gas well comprises combining a first fluid and a second fluid to form an emulsion or a microemulsion. In certain embodiments, the first fluid comprises a plurality of particles (e.g., nanoparticles) and a non-aqueous phase (e.g., comprising a non-aqueous solvent) and the second fluid comprises a surfactant and an aqueous phase (e.g., comprising water). In some cases, the particles (e.g., nanoparticles) are hydrophobic. In some cases, in the emulsion or microemulsion, the nanoparticles are at least partially surrounded (e.g., at least partially encapsulated) by surfactant. In certain embodiments, the nanoparticles are in contact with at least a portion of the non-aqueous phase. In some embodiments, the emulsion or microemulsion may be injected into an oil and/or gas well comprising a wellbore. In certain embodiments, the emulsion or microemulsion is diluted with a dilution fluid prior to injecting into the oil and/or gas well.

The emulsions or microemulsions as described herein may be made by methods known to persons of ordinary skill in the art. For example, in some embodiments, the first fluid is added to the second fluid to form an emulsion or microemulsion. In other embodiments, the second fluid is added to the first fluid to form an emulsion or microemulsion. In some embodiments, the first fluid may have a plurality of particles (e.g., nanoparticles) dispersed in a non-aqueous phases. Additional details regarding methods for forming emulsions or microemulsions are described herein.

It should be understood, that while much of the description herein focuses on microemulsions, this is by no means limiting, and emulsions may be employed where appropriate. In addition, It should be understood, that while much of the description herein focuses on nanoparticles, this is by no means limiting, and other types of particles may be employed where appropriate.

In some embodiments, in the compositions or methods described herein, a portion of the nanoparticles are each at least partially surrounded (e.g., at least partially encapsulated) by surfactant and in contact with at least a portion of a non-aqueous phase. A particle may be fully or partially surrounded (e.g., encapsulated) by the surfactant, and the non-aqueous phase may be present in any suitable amount. As a non-limiting example, for example, a nanoparticle may represent a core and the surfactant may form a shell encapsulating the nanoparticle core. Within at least a portion of the surfactant shell, a portion of the non-aqueous phase is present and is in contact with the nanoparticle. In some embodiments, each of at least some of the particles are fully encapsulated by surfactant. In some embodiments, each of at least some of the particles are partially encapsulated by surfactant. As will be generally understood by those skilled in the art, how much surface area of the nanoparticle is in contact with the non-aqueous phase may depend, at least in part, on the wettability of the nanoparticle by a non-aqueous phase (e.g., a non-aqueous solvent).

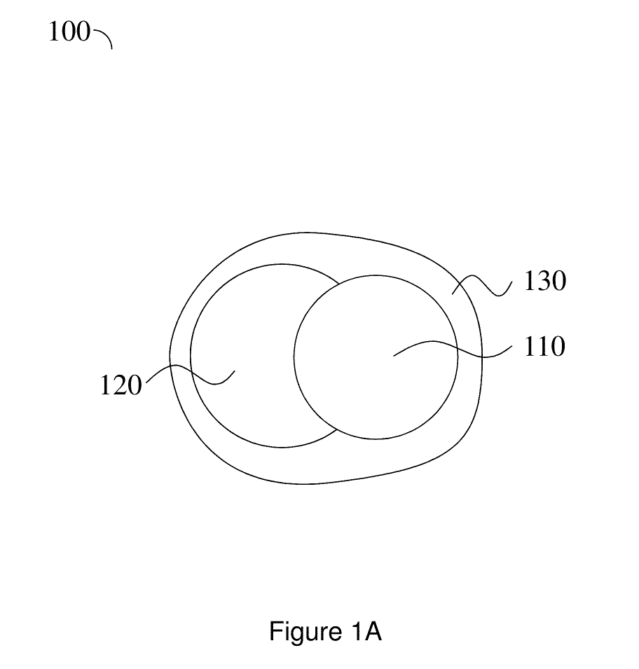

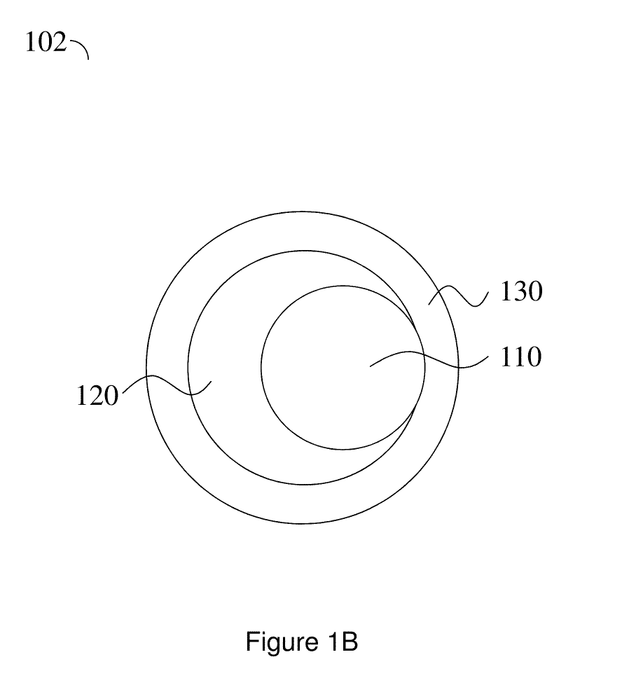

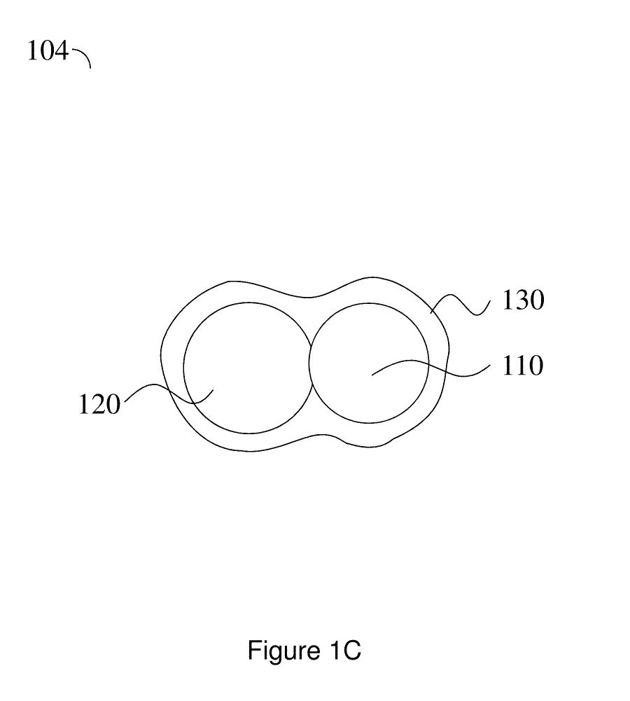

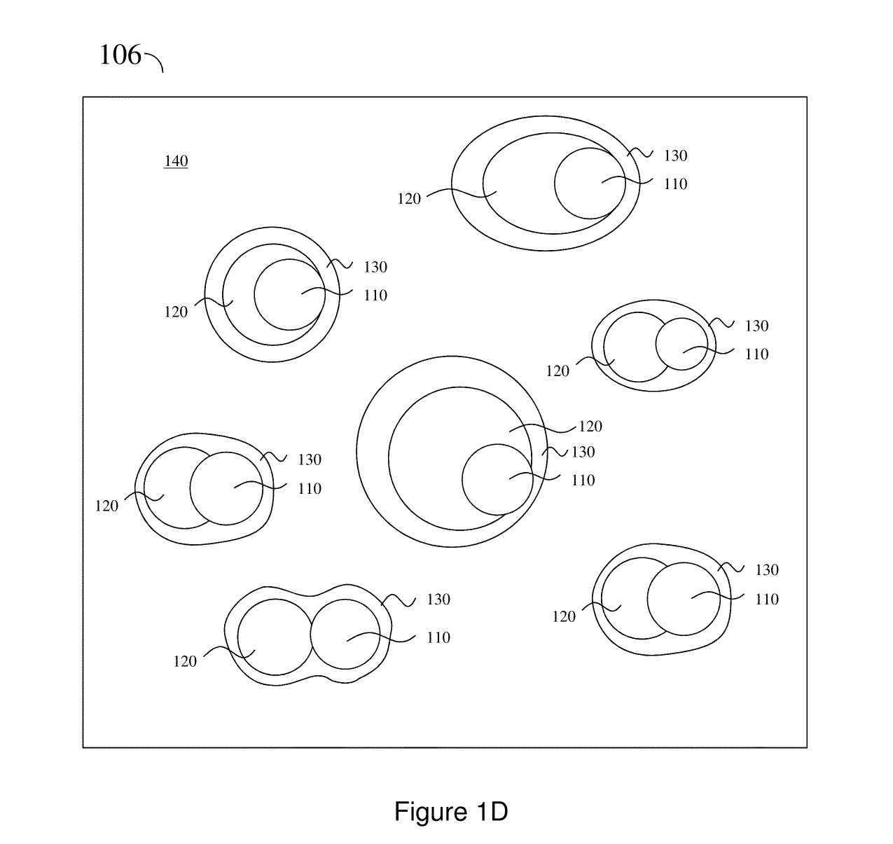

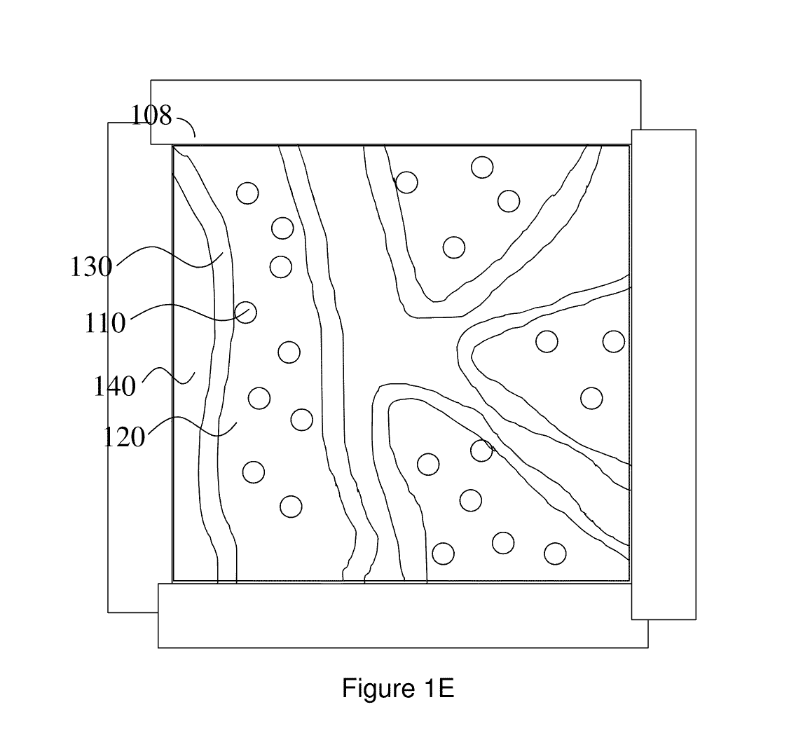

Non-limiting illustrative embodiments are shown in FIGS. 1A-1E. As shown in the non-limiting embodiment illustrated in FIG. 1A, emulsion or microemulsion 100 comprises nanoparticle 110, non-aqueous phase 120 in contact with nanoparticle 110, and surfactant 130 encapsulating the nanoparticle and the non-aqueous phase. As another non-limiting embodiment, as illustrated in FIG. 1B, emulsion or microemulsion 102 comprises nanoparticle 110 partially encapsulated by non-aqueous phase 120 and surfactant 130. In some cases, as illustrated in FIG. 1C, emulsion or microemulsion 104 comprises nanoparticle 110 substantially in contact with surfactant 130 and contacted with a relatively small portion of non-aqueous phase 120. Other possible variations of a nanoparticle being at least partially encapsulated by surfactant and in contact with a non-aqueous phase will be apparent to those of ordinary skill in the art.

It should be understood that in the emulsion or microemulsions described herein, may include a wide variety of arrangements of the nanoparticles being at least partially encapsulated by surfactant and in contact with a non-aqueous phase. For example, as illustrated in FIG. 1D, as another non-limiting embodiment, emulsion 106 comprises a plurality of nanoparticles 110 in aqueous phase 140, each nanoparticle being in contact with non-aqueous phase 120 in varying amounts and encapsulated by surfactant 130.

In certain embodiments, the microemulsion is bicontinuous. In such embodiments, the aqueous and non-aqueous phases may be separated by surfactant and the nanoparticles may be dispersed in the non-aqueous phase. For example, as illustrated in the non-limiting embodiment in FIG. 1E, bicontinuous emulsion 108 comprises a plurality of nanoparticles 110 in contact with (e.g., dispersed in) non-aqueous phase 120 and at least partially surrounded by surfactant 130.

An emulsion or microemulsion as described herein comprising a plurality of nanoparticles may offer several advantages in oil and/or gas well methods and/or applications over a substantially similar emulsion or microemulsion not comprising the nanoparticles, including, but not limited to, increased stabilization of the emulsion or microemulsion, reduced amount of surfactant required to maintain a stable emulsion or microemulsion, and/or reduction in the breakdown of the emulsion or microemulsion during use. In addition, the use of emulsions or microemulsions comprising a plurality of nanoparticles as described herein has been demonstrated to increase the recovery of hydrocarbons from an oil and/or gas well by increasing flowback of the aqueous phase driven by crude oil (e.g., see Examples, below) as compared to as substantially similar emulsion or microemulsion not comprising the nanoparticles.

In some embodiments, emulsions or microemulsion are provided. The terms should be understood to include emulsions or microemulsions that have a water continuous phase, or that have an oil continuous phase, or microemulsions that are bicontinuous or multiple continuous phases of water and oil.

As used herein, the term emulsion is given its ordinary meaning in the art and refers to dispersions of one immiscible liquid in another, in the form of droplets, with diameters approximately in the range of 100-1,000 nanometers. Emulsions may be thermodynamically unstable and/or require high shear forces to induce their formation. As used herein, the term microemulsion is given its ordinary meaning in the art and refers to dispersions of one immiscible liquid in another, in the form of droplets, with diameters approximately in the range of about between about 1 and about 1000 nm, or between 10 and about 1000 nanometers, or between about 10 and about 500 nm, or between about 10 and about 300 nm, or between about 10 and about 100 nm.

Microemulsions may be clear or transparent because they contain nanoparticles smaller than the wavelength of visible light. In addition, microemulsions are homogeneous thermodynamically stable single phases, and form spontaneously, and thus, differ markedly from thermodynamically unstable emulsions, which generally depend upon intense mixing energy for their formation. Microemulsions may be characterized by a variety of advantageous properties including, by not limited to, (i) clarity, (ii) very small nanoparticle size, (iii) ultra-low interfacial tensions, (iv) the ability to combine properties of water and oil in a single homogeneous fluid, (v) shelf life stability, and (vi) ease of preparation.

In some embodiments, the microemulsions described herein are stabilized microemulsions that are formed by the combination of a solvent-surfactant blend with an appropriate oil-based or water-based carrier fluid. Generally, the microemulsion forms upon simple mixing of the components without the need for high shearing generally required in the formation of ordinary emulsions. In some embodiments, the microemulsion is a thermodynamically stable system, and the droplets remain finely dispersed over time. In some cases, the average droplet size ranges from about 10 nm to about 300 nm.

In some embodiments, the emulsion or microemulsion is a single emulsion or microemulsion. For example, the emulsion or microemulsion comprises a single layer of a surfactant. In other embodiments, the emulsion or microemulsion may be a double or multilamellar emulsion or microemulsion. For example, the emulsion or microemulsion comprises two or more layers of a surfactant. In some embodiments, the emulsion or microemulsion comprises a single layer of surfactant surrounding a core (e.g., one or more of water, oil, non-aqueous phase, and/or other additives) or a multiple layers of surfactant (e.g., two or more concentric layers surrounding the core). In certain embodiments, the emulsion or microemulsion comprises two or more immiscible cores (e.g., one or more of water, oil, non-aqueous, and/or other additives which have equal or about equal affinities for the surfactant).

In some embodiments, a microemulsion comprises an aqueous phase (e.g., comprising water), a non-aqueous phase (e.g., comprising a non-aqueous solvent) a plurality of nanoparticles, and a surfactant. In some embodiments, the microemulsion further comprises one or more additives, for example, an alcohol (e.g., an alcohol miscible with water). Details of each of the components of the microemulsions are described in detail herein. In some embodiments, the components of the microemulsions are selected so as to reduce or eliminate the hazards of the microemulsion to the environment and/or the subterranean reservoirs.

The emulsion or microemulsion may comprises any suitable amount of the components described herein. In some embodiments, the emulsion or microemulsion comprises between about 1 wt % and 60 wt % water, between about 1 wt % and 70 wt % non-aqueous phase comprising the plurality of particles (e.g., the plurality nanoparticles), between about 5 wt % and 65 wt % surfactant, between about 0 wt % and about 40 wt % alcohol, and between about 0 wt % and about 30 wt % other additives, versus the total microemulsion composition. In some embodiments, for the formulation above, the water is present in an amount between about 10 wt % and about 55 wt %, or between about 15 wt % and about 45 wt %. In some embodiments, for the formulation above the non-aqueous phase comprising the plurality of particles is present in an amount between about 2 wt % and about 25 wt %, or between about 5 wt % and about 25 wt %. In some embodiments, the non-aqueous phase comprises a terpene. In some embodiments, for the formulations above, an alcohol is present in an amount between about 5 wt % and about 40 wt %, or between about 5 wt % and 35 wt %. In some embodiments, the alcohol comprises isopropanol. In some embodiments, for the formulations above, the surfactant is present in an amount between about 5 wt % and 60 wt %, or between about 10 wt % and 55 wt %. In some embodiments, for the formulations above, a freezing point depression agent is present in an amount between about 1 wt % and about 25 wt %, or between about 1 wt % and about 20 wt %, or between about 3 wt % and about 20 wt %. In some embodiments, for the formulations above, the other additives are present in an amount between about 1 wt % and about 30 wt %, or between about 1 wt % and about 25 wt %, or between about 1 wt % and about 20 wt %. In some embodiments, the other additives comprise one or more salts and/or one or more acids.

As described herein, a microemulsion may be formed by combining a first fluid and a second fluid, wherein the first fluid comprises a plurality of particles (e.g., nanoparticles) and a non-aqueous phase. In some embodiments, the microemulsion comprises between about 5 wt % to about 70 wt %, between about 10 wt % and about 50 wt %, or between about 15 wt % and about 30 wt % of the first fluid, versus the total microemulsion composition. In some embodiments, the first fluid comprises between about 5 wt % and about 50% wt %, between about 10 wt % and about 40 wt %, or between about 15 wt % and about 30 wt % particles (e.g., nanoparticles) versus the first fluid composition.

In some embodiments, the emulsion or microemulsion comprises a plurality or particles. In some embodiments, the plurality of particles are a plurality of nanoparticles. As used herein, the term nanoparticle generally refers to a particle having a maximum cross-sectional dimension of no more than 100 nanometers.

The plurality of nanoparticles included in the emulsion or microemulsion may have any suitable average diameter. As used herein, the average diameter of nanoparticles refers to the average largest cross-sectional dimension of the nanoparticles. In certain embodiments, the plurality of nanoparticles may have an average diameter of between about 0.1 nm and about 100 nm, between about 1 nm and about 100 nm, between about 5 nm and about 100 nm, between about 1 nm and about 50 nm, between about 5 nm and about 50 nm, between about 1 nm and about 40 nm, between about 5 nm and about 40 nm, between about 1 nm and about 30 nm, between about 5 nm and about 30 nm, or between about 7 nm and about 20 nm. In some embodiments, the plurality of nanoparticles have an average diameter of less than or equal to about 30 nm, less than or equal to about 25 nm, less than or equal to about 20 nm, less than or equal to about 15 nm, less than or equal to about 10 nm, or less than or equal to about 7 nm. In certain embodiments, the plurality of nanoparticles have an average diameter of at least about 5 nm, at least about 7 nm, at least about 10 nm, at least about 15 nm, at least about 20 nm, or at least about 25 nm. Combinations of the above-referenced ranges are also possible.

The plurality of nanoparticles may be made from any suitable material. Non-limiting examples of suitable nanoparticle materials include ceramics, metals, metal oxides (e.g., silica, titania, alumina, zirconia, vanadia, ceria, iron oxide, antimony oxide, tin oxide, aluminum, zinc oxide, boron, and combinations thereof), polymers (e.g., polystyrene), resins (e.g., silicone resin), and pigments (e.g., chromite spinel pigments). In some embodiments, the plurality of nanoparticles comprise a plurality of hydrophobized nanoparticles. In certain embodiments, the plurality of nanoparticles comprise silica (e.g., hydrophobized silica).

Suitable nanoparticles may exhibit a range of surface properties. For example, in some embodiments, the plurality of nanoparticles are hydrophobic. As will be understood by those skilled in the art, the term hydrophobic generally refers to the property of a surface to repel water. For example, a water droplet placed on the surface of a hydrophobic material will generally exhibit a high contact angle (e.g., a contact angle of greater than about 90 degrees), as defined by the angle between the material surface of the water droplet at the point of contact with the material and the material itself. In some embodiments, the surface of a nanoparticle is treated such that the surface becomes hydrophobic. Alternatively, in other embodiments, the nanoparticles are hydrophilic.

A microemulsion generally comprises a non-aqueous phase, wherein the non-aqueous phase comprises one or more non-aqueous solvents. In some embodiments, the non-aqueous solvent is non-polar. In some embodiments, the non-aqueous phase may comprise more than one or two types of non-aqueous solvents, for example, three, four, five, six, or more, types of non-aqueous solvents. In some embodiments, the non-aqueous phase comprises a first type of non-aqueous solvent and a second type of non-aqueous solvent. The first type of non-aqueous solvent to the second type of non-aqueous solvent in the non-aqueous phase may be present in any suitable ratio. In some embodiments, the ratio of the first type of non-aqueous solvent to the second type of non-aqueous solvent by weight is between about 4:1 and 1:4, or between 2:1 and 1:2, or about 1:1. In some embodiments, the non-aqueous solvent(s) is selected so as to promote dispersion of the plurality of particles.

In some embodiments, the non-aqueous phase comprises one or more hydrocarbon solvents. As will be understood by those skilled in the art, the term hydrocarbon solvent generally refers to a solvents comprising hydrogen and carbon and which are generally immiscible with water. In some embodiments, the hydrocarbon solvent is non-polar. Those or ordinary skill in the art will be aware of suitable hydrocarbon solvents. Non-limiting examples of hydrocarbon solvents include cyclic or acyclic, branched or unbranched alkanes, cyclic or acyclic, branched or unbranched alkenes, branched or unbranched dialkylethers, aromatic compounds, and terpenes.

Non-limiting examples of cyclic or acyclic, branched or unbranched alkanes include hexane, heptane, octane, nonane, decane, undecane, dodecane, isomers of methylpentane (e.g., 2-methylpentane, 3-methylpentane), isomers of dimethylbutane (e.g., 2,2-dimethylbutane, 2,3-dimethylbutane), isomers of methylhexane (e.g., 2-methylhexane, 3-methylhexane), isomers of ethylpentane (e.g., 3-ethylpentane), isomers of dimethylpentane (e.g., 2,2,-dimethylpentane, 2,3-dimethylpentane, 2,4-dimethylpentane, 3,3-dimethylpentane), isomers of trimethylbutane (e.g., 2,2,3-trimethylbutane), isomers of methylheptane (e.g., 2-methylheptane, 3-methylheptane, 4-methylheptane), isomers of dimethylhexane (e.g., 2,2-dimethylhexane, 2,3-dimethylhexane, 2,4-dimethylhexane, 2,5-dimethylhexane, 3,3-dimethylhexane, 3,4-dimethylhexane), isomers of ethylhexane (e.g., 3-ethylhexane), isomers of trimethylpentane (e.g., 2,2,3-trimethylpentane, 2,2,4-trimethylpentane, 2,3,3-trimethylpentane, 2,3,4-trimethylpentane), isomers of ethylmethylpentane (e.g., 3-ethyl-2-methylpentane, 3-ethyl-3-methylpentane), cyclohexane, methylcyclopentane, ethylcyclobutane, propylcyclopropane, isopropylcyclopropane, dimethylcyclobutane, cycloheptane, methylcyclohexane, dimethylcyclopentane, ethylcyclopentane, trimethylcyclobutane, cyclooctane, methylcycloheptane, dimethylcyclohexane, ethylcyclohexane, cyclononane, methylcyclooctane, dimethylcycloheptane, ethylcycloheptane, trimethylcyclohexane, ethylmethylcyclohexane, propylcyclohexane, cyclodecane, and. heptane, octane, nonane, decane, 2,2,4-trimethylpentane (isooctane), and propylcyclohexane.

Non-limiting examples of cyclic or acyclic, branched or unbranched alkenes include isomers of hexene (e.g., 1-hexene, 2-hexene), isomers of hexadiene (e.g., 1,3-hexadiene, 1,4-hexadiene), isomers of heptene (e.g., 1-heptene, 2-heptene, 3-heptene), isomers of heptadiene (e.g., 1,5-heptadiene, 1-6, heptadiene), isomers of octene (e.g., 1-octene, 2-octene, 3-octene), isomers of octadiene (e.g., 1,7-octadiene), isomers of nonene, isomers of nonadiene, isomers of decene, isomers of decadiene, isomers of undecene, isomers of undecadiene, isomers of dodecene, isomers of dodecadiene, alpha-olefins (e.g., 1-hexene, 1-heptene, 1-octene, 1-nonene, 1-decene, 1-undecene, 1-dodecene), isomers of methylpentene, isomers of dimethylpentene, isomers of ethylpentene, isomers of methylethylpentene, isomers of propylpentene, isomers of methylhexene, isomers of ethylhexene, isomers of dimethylhexene, isomers of methylethylhexene, isomers of methylheptene, isomers of ethylheptene, isomers of dimethylhexptene, and isomers of methylethylheptene.

Non-limiting examples of branched or unbranched dialkylether compounds are those having the formula CₙH₂ₙ₊₁OCₘH₂ₘ₊₁ wherein n+m is between 1 and 16. In some cases, n+m is between 2 and 16, or between 6 and 12, or between 6 and 10, or between 6 and 8. Non-limiting examples of branched or unbranched dialkylether compounds having the formula CₙH₂ₙ₊₁OCₘH₂ₘ₊₁ include dimethyl ether, diethyl ether, isomers of C₃H₇OC₃H₇, isomers of C₄H₉OC₃H₇, isomers of C₅H₁₁OC₃H₇, isomers of C₆H₁₃OC₃H₇, isomers of C₄H₉OC₄H₉, isomers of C₄H₉OC₅H₁₁, isomers of C₄H₉OC₆HH₁₃, isomers of C₅H₁₁OC₆H₁₃, and isomers of C₆H₁₃OC₆H₁₃. In a particular embodiment, the branched or unbranched dialklyether is an isomer C₆H₁₃OC₆H₁₃ (e.g., dihexylether).

Non-limiting examples of aromatic compounds include toluene, benzene, dimethylbenzene, butylbenzene, hexylbenzene, mesitylene, light aromatic naphtha, and heavy aromatic naphtha.

In some embodiments, the non-aqueous solvent comprises a terpene and/or a terpenoid. In some embodiments, the terpene or terpenoid comprises a first type of terpene or terpenoid and a second type of terpene or terpenoid. Terpenes may be generally classified as monoterpenes (e.g., having two isoprene units), sesquiterpenes (e.g., having 3 isoprene units), diterpenes, or the like. The term terpenoid also includes natural degradation products, such as ionones, and natural and synthetic derivatives, e.g., terpene alcohols, aldehydes, ketones, acids, esters, epoxides, and hydrogenation products (e.g., see Ullmann's Encyclopedia of Industrial Chemistry, 2012, pages 29-45, herein incorporated by reference). It should be understood, that while much of the description herein focuses on terpenes, this is by no means limiting, and terpenoids may be employed where appropriate. In some cases, the terpene is a naturally occurring terpene. In some cases, the terpene is a non-naturally occurring terpene and/or a chemically modified terpene (e.g., saturated terpene, terpene amine, fluorinated terpene, or silylated terpene).

In some embodiments, the terpene is a monoterpene. Monoterpenes may be further classified as acyclic, monocyclic, and bicyclic (e.g., with a total number of carbons in the range between 18-20), as well as whether the monoterpene comprises one or more oxygen atoms (e.g., alcohol groups, ester groups, ether groups, carbonyl groups, etc.). In some embodiments, the terpene is an oxygenated terpene, for example, a terpene comprising an alcohol, an aldehyde, and/or a ketone group. In some embodiments, the terpene comprises an alcohol group. Non-limiting examples of terpenes comprising an alcohol group are linalool, geraniol, nopol, α-terpineol, and menthol. In some embodiments, the terpene comprises an ether-oxygen, for example, eucalyptol, or a carbonyl oxygen, for example, menthone. In some embodiments, the terpene does not comprise an oxygen atom, for example, d-limonene.

Non-limiting examples of terpenes include linalool, geraniol, nopol, α-terpineol, menthol, eucalyptol, menthone, d-limonene, terpinolene, β-occimene, γ-terpinene, α-pinene, and citronellene. In a particular embodiment, the terpene is selected from the group consisting of α-terpeneol, α-pinene, nopol, and eucalyptol. In one embodiment, the terpene is nopol. In another embodiment, the terpene is eucalyptol. In some embodiments, the terpene is not limonene (e.g., d-limonene). In some embodiments, the emulsion is free of limonene.

In some embodiments, the terpene is a non-naturally occurring terpene and/or a chemically modified terpene (e.g., saturated terpene). In some cases, the terpene is a partially or fully saturated terpene (e.g., p-menthane, pinane). In some cases, the terpene is a non-naturally occurring terpene. Non-limiting examples of non-naturally occurring terpenes include, menthene, p-cymene, r-carvone, terpinenes (e.g., alpha-terpinenes, beta-terpinenes, gamma-terpinenes), dipentenes, terpinolenes, borneol, alpha-terpinamine, and pine oils.

In certain embodiments, the non-aqueous phase utilized in the emulsion or microemulsion herein may comprise one or more impurities. For example, in some embodiments, a non-aqueous solvent (e.g., a terpene) is extracted from a natural source (e.g., citrus, pine), and may comprise one or more impurities present from the extraction process. In some embodiment, the non-aqueous phase comprises a crude cut (e.g., uncut crude oil, for example, made by settling, separation, heating, etc.). In some embodiments, a non-aqueous solvent comprises a crude oil (e.g., naturally occurring crude oil, uncut crude oil, crude oil extracted from the wellbore, synthetic crude oil, crude citrus oil, crude pine oil, eucalyptus, etc.). In some embodiments, a non-aqueous solvent comprises a citrus extract (e.g., crude orange oil, orange oil, etc.).

Generally, the microemulsion comprises an aqueous phase. Generally, the aqueous phase comprises water. The water may be provided from any suitable source (e.g., sea water, fresh water, deionized water, reverse osmosis water, water from field production). The water may be present in any suitable amount. In some embodiments, the total amount of water present in the microemulsion is between about 1 wt % about 95 wt %, or between about 1 wt % about 90 wt %, or between about 1 wt % and about 60 wt %, or between about 5 wt % and about 60 wt % or between about 10 and about 55 wt %, or between about 15 and about 45 wt %, versus the total microemulsion composition.

The aqueous phase to non-aqueous phase (optionally comprising the nanoparticles) ratio in a microemulsion may be varied. In some embodiments, the ratio of aqueous phase to non-aqueous phase, along with other parameters of the non-aqueous phase may be varied. In some embodiments, the ratio of water to non-aqueous phase (optionally comprising the nanoparticles) by weight is between about 15:1 and 1:10, or between 9:1 and 1:4, or between 3.2:1 and 1:4.

In some embodiments, the aqueous phase further comprises an alcohol (e.g., isopropyl alcohol), as described in more detail below.

In some embodiments, the microemulsion comprises a surfactant. The microemulsion may comprise a single surfactant or a combination of two or more surfactants. For example, in some embodiments, the surfactant comprises a first type of surfactant and a second type of surfactant. The term surfactant, as used herein, is given its ordinary meaning in the art and refers to compounds having an amphiphilic structure which gives them a specific affinity for oil/water-type and water/oil-type interfaces which helps the compounds to reduce the free energy of these interfaces and to stabilize the dispersed phase of a microemulsion. The term surfactant encompasses cationic surfactants, anionic surfactants, amphoteric surfactants, nonionic surfactants, zwitterionic surfactants, and mixtures thereof. In some embodiments, the surfactant is a nonionic surfactant. Nonionic surfactants generally do not contain any charges. Amphoteric surfactants generally have both positive and negative charges, however, the net charge of the surfactant can be positive, negative, or neutral, depending on the pH of the solution. Anionic surfactants generally possess a net negative charge. Cationic surfactants generally possess a net positive charge. Zwitterionic surfactants are generally not pH dependent. A zwitterion is a neutral molecule with a positive and a negative electrical charge, though multiple positive and negative charges can be present. Zwitterions are distinct from dipole, at different locations within that molecule.

In some embodiments, the surfactant is an amphiphilic block copolymer where one block is hydrophobic and one block is hydrophilic. In some cases, the total molecular weight of the polymer is greater than 5000 daltons. The hydrophilic block of these polymers can be nonionic, anionic, cationic, amphoteric, or zwitterionic. The term surface energy, as used herein, is given its ordinary meaning in the art and refers to the extent of disruption of intermolecular bonds that occur when the surface is created (e.g., the energy excess associated with the surface as compared to the bulk). Generally, surface energy is also referred to as surface tension (e.g., for liquid-gas interfaces) or interfacial tension (e.g., for liquid-liquid interfaces). As will be understood by those skilled in the art, surfactants generally orient themselves across the interface to minimize the extent of disruption of intermolecular bonds (i.e. lower the surface energy). Typically, a surfactant at an interface between polar and non-polar phases orient themselves at the interface such that the difference in polarity is minimized.

Those of ordinary skill in the art will be aware of methods and techniques for selecting surfactants for use in the microemulsions described herein. In some cases, the surfactant(s) are matched to and/or optimized for the particular oil or solvent in use. In some embodiments, the surfactant(s) are selected by mapping the phase behavior of the microemulsion and choosing the surfactant(s) that gives the desired range of phase behavior. In some cases, the stability of the microemulsion over a wide range of temperatures is targeted as the microemulsion may be subject to a wide range of temperatures due to the environmental conditions present at the subterranean formation and/or reservoir.

The surfactant may be present in the microemulsion in any suitable amount. In some embodiments, the surfactant is present in an amount between about 0 wt % and about 99 wt %, or between about 1 wt % and about 90 wt %, or between about 0 wt % and about 60 wt %, or between about 1 wt % and about 60 wt %, or between about 5 wt % and about 60 wt %, or between about 10 wt % and about 60 wt %, or between about 5 wt % and about 65 wt %, or between about 5 wt % and about 55 wt %, or between about 10 wt % and about 55 wt %, or between about 2 wt % and about 50 wt %, or between about 0 wt % and about 40 wt %, or between about 15 wt % and about 55 wt %, or between about 20 wt % and about 50 wt %, versus the total microemulsion composition.

Suitable surfactants for use with the compositions and methods described herein will be known in the art. In some embodiments, the surfactant is an alkyl polyglycol ether, for example, having 2-250 ethylene oxide (EO) (e.g., or 2-200, or 2-150, or 2-100, or 2-50, or 2-40) units and alkyl groups of 4-20 carbon atoms. In some embodiments, the surfactant is an alkylaryl polyglycol ether having 2-250 EO units (e.g., or 2-200, or 2-150, or 2-100, or 2-50, or 2-40) and 8-20 carbon atoms in the alkyl and aryl groups. In some embodiments, the surfactant is an ethylene oxide/propylene oxide (EO/PO) block copolymer having 2-250 EO or PO units (e.g., or 2-200, or 2-150, or 2-100, or 2-50, or 2-40). In some embodiments, the surfactant is a fatty acid polyglycol ester having 6-24 carbon atoms and 2-250 EO units (e.g., or 2-200, or 2-150, or 2-100, or 2-50, or 2-40). In some embodiments, the surfactant is a polyglycol ether of hydroxyl-containing triglycerides (e.g., castor oil). In some embodiments, the surfactant is an alkylpolyglycoside of the general formula R″—O—Zₙ, where R″ denotes a linear or branched, saturated or unsaturated alkyl group having on average 8-24 carbon atoms and Zₙ denotes an oligoglycoside group having on average n=1-10 hexose or pentose units or mixtures thereof. In some embodiments, the surfactant is a fatty ester of glycerol, sorbitol, or pentaerythritol. In some embodiments, the surfactant is an amine oxide (e.g., dodecyldimethylamine oxide). In some embodiments, the surfactant is an alkyl sulfate, for example having a chain length of 8-18 carbon atoms, alkyl ether sulfates having 8-18 carbon atoms in the hydrophobic group and 1-40 ethylene oxide (E0) or propylene oxide (PO) units. In some embodiments, the surfactant is a sulfonate, for example, an alkyl sulfonate having 8-18 carbon atoms, an alkylaryl sulfonate having 8-18 carbon atoms, an ester or half ester of sulfosuccinic acid with monohydric alcohols or alkylphenols having 4-15 carbon atoms, or a multisulfonate (e.g., comprising two, three, four, or more, sulfonate groups). In some cases, the alcohol or alkylphenol can also be ethoxylated with 1-250 EO units (e.g., or 2-200, or 2-150, or 2-100, or 2-50, or 2-40). In some embodiments, the surfactant is an alkali metal salt or ammonium salt of a carboxylic acid or poly(alkylene glycol) ether carboxylic acid having 8-20 carbon atoms in the alkyl, aryl, alkaryl or aralkyl group and 1-250 EO or PO units (e.g., or 2-200, or 2-150, or 2-100, or 2-50, or 2-40). In some embodiments, the surfactant is a partial phosphoric ester or the corresponding alkali metal salt or ammonium salt, e.g., an alkyl and alkaryl phosphate having 8-20 carbon atoms in the organic group, an alkylether phosphate or alkarylether phosphate having 8-20 carbon atoms in the alkyl or alkaryl group and 1-250 EO units (e.g., or 2-200, or 2-150, or 2-100, or 2-50, or 2-40). In some embodiments, the surfactant is a salt of primary, secondary, or tertiary fatty amine having 8-24 carbon atoms with acetic acid, sulfuric acid, hydrochloric acid, and phosphoric acid. In some embodiments, the surfactant is a quaternary alkyl- and alkylbenzylammonium salt, whose alkyl groups have 1-24 carbon atoms (e.g., a halide, sulfate, phosphate, acetate, or hydroxide salt). In some embodiments, the surfactant is an alkylpyridinium, an alkylimidazolinium, or an alkyloxazolinium salt whose alkyl chain has up to 18 carbons atoms (e.g., a halide, sulfate, phosphate, acetate, or hydroxide salt). In some embodiments, the surfactant is amphoteric or zwitterionic, including sultaines (e.g., cocamidopropyl hydroxysultaine), betaines (e.g., cocamidopropyl betaine), or phosphates (e.g., lecithin). Non-limiting examples of specific surfactants include a linear C₁₂-C₁₅ ethoxylated alcohols with 5-12 moles of EO, lauryl alcohol ethoxylate with 4-8 moles of EO, nonyl phenol ethoxylate with 5-9 moles of EO, octyl phenol ethoxylate with 5-9 moles of EO, tridecyl alcohol ethoxylate with 5-9 moles of EO, Pluronic® matrix of EO/PO copolymers, ethoxylated cocoamide with 4-8 moles of EO, ethoxylated coco fatty acid with 7-11 moles of EO, and cocoamidopropyl amine oxide.

In some embodiments, the surfactant is a siloxane surfactant as described in U.S. patent application Ser. No. 13/831,410, filed Mar. 14, 2014, herein incorporated by reference.

In some embodiments, the surfactant is a Gemini surfactant. Gemini surfactants generally have the structure of multiple amphiphilic molecules linked together by one or more covalent spacers. In some embodiments, the surfactant is an extended surfactant, wherein the extended surfactants has the structure where a non-ionic hydrophilic spacer (e.g. ethylene oxide or propylene oxide) connects an ionic hydrophilic group (e.g. carboxylate, sulfate, phosphate).

In some embodiments the surfactant is an alkoxylated polyimine with a relative solubility number (RSN) in the range of 5-20. As will be known to those of ordinary skill in the art, RSN values are generally determined by titrating water into a solution of surfactant in 1,4dioxane. The RSN values is generally defined as the amount of distilled water necessary to be added to produce persistent turbidity. In some embodiments the surfactant is an alkoxylated novolac resin (also known as a phenolic resin) with a relative solubility number in the range of 5-20. In some embodiments the surfactant is a block copolymer surfactant with a total molecular weight greater than 5000 daltons. The block copolymer may have a hydrophobic block that is comprised of a polymer chain that is linear, branched, hyperbranched, dendritic or cyclic. Non-limiting examples of monomeric repeat units in the hydrophobic chains of block copolymer surfactants are isomers of acrylic, methacrylic, styrenic, isoprene, butadiene, acrylamide, ethylene, propylene and norbornene. The block copolymer may have a hydrophilic block that is comprised of a polymer chain that is linear, branched, hyper branched, dendritic or cyclic. Non-limiting examples of monomeric repeat units in the hydrophilic chains of the block copolymer surfactants are isomers of acrylic acid, maleic acid, methacrylic acid, ethylene oxide, and acrylamine.

In some embodiments, the emulsion, microemulsion, or dilution fluid may comprise one or more additives in addition to an aqueous phase, non-aqueous phase (e.g., as described herein), plurality of nanoparticles, and surfactant (e.g., one or more types of surfactants). In some embodiments, the additive is an alcohol, a freezing point depression agent, an acid, a salt, a proppant, a scale inhibitor, a friction reducer, a biocide, a corrosion inhibitor, a buffer, a viscosifier, a clay swelling inhibitor, an oxygen scavenger, and/or a clay stabilizer.

In some embodiments, the microemulsion and/or dilution fluid comprises an alcohol. The alcohol may serve as a coupling agent between the non-aqueous phase and the surfactant and aid in the stabilization of the microemulsion. The alcohol may also lower the freezing point of the microemulsion. The microemulsion may comprise a single alcohol or a combination of two or more alcohols. In some embodiments, the alcohol is selected from primary, secondary and tertiary alcohols having between 1 and 20 carbon atoms. In some embodiments, the alcohol comprises a first type of alcohol and a second type of alcohol. Non-limiting examples of alcohols include methanol, ethanol, isopropanol, n-propanol, n-butanol, i-butanol, sec-butanol, iso-butanol, and t-butanol. In some embodiments, the alcohol is ethanol or isopropanol. In some embodiments, the alcohol is isopropanol.

The alcohol may be present in the microemulsion and/or dilution fluid in any suitable amount. In some embodiments, the alcohol is present in an amount between about 0 wt % and about 50 wt %, or between about 0.1 wt % and about 50 wt %, or between about 1 wt % and about 50 wt %, or between about 2 wt % and about 50 wt % or between about 5 wt % and about 40 wt %, or between about 5 wt % and 35 wt %, versus the total microemulsion composition and/or dilution fluid.

In some embodiments, the microemulsion and/or dilution fluid comprises a freezing point depression agent. The microemulsion may comprise a single freezing point depression agent or a combination of two or more freezing point depression agents. For example, in some embodiments, the freezing point depression agent comprises a first type of freezing point depression agent and a second type of freezing point depression agent. The term freezing point depression agent is given its ordinary meaning in the art and refers to a compound which is added to a solution to reduce the freezing point of the solution. That is, a solution comprising the freezing point depression agent has a lower freezing point as compared to an essentially identical solution not comprising the freezing point depression agent. Those of ordinary skill in the art will be aware of suitable freezing point depression agents for use in the microemulsions described herein. Non-limiting examples of freezing point depression agents include primary, secondary, and tertiary alcohols with between 1 and 20 carbon atoms. In some embodiments, the alcohol comprises at least 2 carbon atoms, alkylene glycols including polyalkylene glycols, and salts. Non-limiting examples of alcohols include methanol, ethanol, i-propanol, n-propanol, t-butanol, n-butanol, n-pentanol, n-hexanol, and 2-ethyl-hexanol. In some embodiments, the freezing point depression agent is not methanol (e.g., due to toxicity). Non-limiting examples of alkylene glycols include ethylene glycol (EG), polyethylene glycol (PEG), propylene glycol (PG), and triethylene glycol (TEG). In some embodiments, the freezing point depression agent is not ethylene oxide (e.g., due to toxicity). In some embodiments, the freezing point depression agent comprises an alcohol and an alkylene glycol. In some embodiments, the freezing point depression agent comprises a carboxycyclic acid salt and/or a di-carboxycylic acid salt. Another non-limiting example of a freezing point depression agent is a combination of choline chloride and urea. In some embodiments, the microemulsion comprising the freezing point depression agent is stable over a wide range of temperatures, for example, between about −50° F. to 200° F.

The freezing point depression agent may be present in the microemulsion and/or dilution fluid in any suitable amount. In some embodiments, the freezing point depression agent is present in an amount between about 0 wt % and about 70 wt %, or between about 0.5 and 30 wt %, or between about 1 wt % and about 40 wt %, or between about 0 wt % and about 25 wt %, or between about 1 wt % and about 25 wt %, or between about 1 wt % and about 20 wt %, or between about 3 wt % and about 20 wt %, or between about 8 wt % and about 16 wt %, versus the total microemulsion composition or dilution fluid.

In some embodiments, the microemulsion and/or the dilution fluid comprises a salt. The presence of the salt may reduce the amount of water needed as a carrier fluid, and in addition, may lower the freezing point of the microemulsion and/or the dilution fluid. The microemulsion may comprise a single salt or a combination of two or more salts. For example, in some embodiments, the salt comprises a first type of salt and a second type of salt. Non-limiting examples of salts include salts comprising K, Na, Br, Cr, Cs, or Li, for example, halides of these metals, including NaCl, KCl, CaCl₂, and MgCl₂.

The salt may be present in the microemulsion and/or the dilution fluid in any suitable amount. In some embodiments, the salt is present in an amount between about 0 wt % and about 5 wt %, or between about 0.5 and 5 wt %, or between about 1 wt % and about 5 wt %, or between about 2 wt % and about 5 wt %, or between about 3 wt % and about 5 wt %, or between about 1 wt % and about 3 wt %, or between about 0.1 wt % and about 2 wt %, versus the total microemulsion composition or dilution fluid.

In addition to the alcohol, freezing point depression agent, and/or the salt, the microemulsion and/or the dilution fluid may comprise other additives. For example, the microemulsion and/or the dilution fluid may comprise an acid. Further non-limiting examples of other additives include proppants, scale inhibitors, friction reducers, biocides, corrosion inhibitors, buffers, viscosifiers, clay swelling inhibitors, paraffin dispersing additives, asphaltene dispersing additives, and oxygen scavengers.

Non-limiting examples of proppants (e.g., propping agents) include grains of sand, glass beads, crystalline silica (e.g., Quartz), hexamethylenetetramine, ceramic proppants (e.g., calcined clays), resin coated sands, and resin coated ceramic proppants. Other proppants are also possible and will be known to those skilled in the art.

Non-limiting examples of scale inhibitors include one or more of methyl alcohol, organic phosphonic acid salts (e.g., phosphonate salt), polyacrylate, ethane-1,2-diol, calcium chloride, and sodium hydroxide. Other scale inhibitors are also possible and will be known to those skilled in the art.

Non-limiting examples of buffers include acetic acid, acetic anhydride, potassium hydroxide, sodium hydroxide, and sodium acetate. Other buffers are also possible and will be known to those skilled in the art.

Non-limiting examples of corrosion inhibitors include isopropanol, quaternary ammonium compounds, thiourea/formaldehyde copolymers, propargyl alcohol and methanol. Other corrosion inhibitors are also possible and will be known to those skilled in the art.

Non-limiting examples of biocides include didecyl dimethyl ammonium chloride, gluteral, Dazomet, bronopol, tributyl tetradecyl phosphonium chloride, tetrakis (hydroxymethyl) phosphonium sulfate, AQUCAR™, UCARCIDE™, glutaraldehyde, sodium hypochlorite, and sodium hydroxide. Other biocides are also possible and will be known to those skilled in the art.

Non-limiting examples of clay swelling inhibitors include quaternary ammonium chloride and tetramethylammonium chloride. Other clay swelling inhibitors are also possible and will be known to those skilled in the art.

Non-limiting examples of friction reducers include petroleum distillates, ammonium salts, polyethoxylated alcohol surfactants, and anionic polyacrylamide copolymers. Other friction reducers are also possible and will be known to those skilled in the art.

Non-limiting examples of oxygen scavengers include sulfites, and bisulfites. Other oxygen scavengers are also possible and will be known to those skilled in the art.

Non-limiting examples of paraffin dispersing additives and asphaltene dispersing additives include active acidic copolymers, active alkylated polyester, active alkylated polyester amides, active alkylated polyester imides, aromatic naphthas, and active amine sulfonates. Other paraffin dispersing additives are also possible and will be known to those skilled in the art.

In some embodiments, the microemulsion and/or the dilution fluid comprises a clay stabilizer. The microemulsion and/or the dilution fluid may comprise a single clay stabilizer or a combination of two or more clay stabilizers. For example, in some embodiments, the salt comprises a first type of clay stabilizer and a second type of clay stabilizer. Non-limiting examples of clay stabilizers include salts above, polymers (PAC, PHPA, etc), glycols, sulfonated asphalt, lignite, sodium silicate, and choline chloride.

In some embodiments, for the formulations above, the other additives are present in an amount between about 0 wt % about 70 wt %, or between about 0 wt % and about 30 wt %, or between about 1 wt % and about 30 wt %, or between about 1 wt % and about 25 wt %, or between about 1 and about 20 wt %, versus the total microemulsion composition or the dilution fluid.

In some embodiments, the microemulsion and/or the dilution fluid comprises an acid or an acid precursor. For example, the microemulsion and/or the dilution fluid may comprise an acid when used during acidizing operations. The microemulsion and/or the dilution fluid may comprise a single acid or a combination of two or more acids. For example, in some embodiments, the acid comprises a first type of acid and a second type of acid. Non-limiting examples of acids or di-acids include hydrochloric acid, acetic acid, formic acid, succinic acid, maleic acid, malic acid, lactic acid, and hydrochloric-hydrofluoric acids. In some embodiments, the microemulsion and/or the dilution fluid comprises an organic acid or organic di-acid in the ester (or di-ester) form, whereby the ester (or diester) is hydrolyzed in the wellbore and/or reservoir to form the parent organic acid and an alcohol in the wellbore and/or reservoir. Non-limiting examples of esters or di-esters include isomers of methyl formate, ethyl formate, ethylene glycol diformate, α,α-4-trimethyl-3-cyclohexene-1-methylformate, methyl lactate, ethyl lactate, α,α-4-trimethyl 3-cyclohexene-1-methyllactate, ethylene glycol dilactate, ethylene glycol diacetate, methyl acetate, ethyl acetate, α,α,-4-trimethyl-3-cyclohexene-1-methylacetate, dimethyl succinate, dimethyl maleate, di(α,α-4-trimethyl-3-cyclohexene-1-methyl)succinate, 1-methyl-4-(1-methylethenyl)-cyclohexylformate, 1-methyl-4-(1-ethylethenyl)cyclohexylactate, 1-methyl-4-(1-methylethenyl)cyclohexylacetate, di(1-methy-4-(1-methylethenyl)cyclohexyl)succinate.

In some embodiments, the components of the microemulsion and/or the amounts of the components are selected such that the microemulsion is stable over a wide-range of temperatures. For example, the microemulsion may exhibit stability between about −40° F. and about 400° F., or between about −40° F. and about 300° F. or between about −40° F. and about 150° F. Those of ordinary skill in the art will be aware of methods and techniques for determining the range of stability of the microemulsion. For example, the lower boundary may be determined by the freezing point and the upper boundary may be determined by the cloud point and/or using spectroscopy methods. Stability over a wide range of temperatures may be important in embodiments where the microemulsions are being employed in applications comprising environments wherein the temperature may vary significantly, or may have extreme highs (e.g., desert) or lows (e.g., artic).

The microemulsions described herein may be formed using methods known to those of ordinary skill in the art. In some embodiments, the aqueous and non-aqueous phases may be combined (e.g., the water and the solvent(s)), followed by addition of a surfactant(s) and optionally (e.g., freezing point depression agent(s)) and agitation. The strength, type, and length of the agitation may be varied as known in the art depending on various factors including the components of the microemulsion, the quantity of the microemulsion, and the resulting type of microemulsion formed. For example, for small samples, a few seconds of gentle mixing can yield a microemulsion, whereas for larger samples, longer agitation times and/or stronger agitation may be required. Agitation may be provided by any suitable source, for example, a vortex mixer, a stirrer (e.g., magnetic stirrer), etc.

Any suitable method for injecting the microemulsion (e.g., a diluted microemulsion) into a wellbore may be employed. For example, in some embodiments, the microemulsion, optionally diluted, may be injected into a subterranean formation by injecting it into a well or wellbore in the zone of interest of the formation and thereafter pressurizing it into the formation for the selected distance. Methods for achieving the placement of a selected quantity of a mixture in a subterranean formation are known in the art. The well may be treated with the microemulsion for a suitable period of time. The microemulsion and/or other fluids may be removed from the well using known techniques, including producing the well.

It should be understood, that in embodiments where a microemulsion is said to be injected into a wellbore, that the microemulsion may be diluted and/or combined with other liquid component(s) (e.g., a dilution fluid) prior to and/or during injection (e.g., via straight tubing, via coiled tubing, etc.). For example, in some embodiments, the microemulsion is diluted with an aqueous carrier fluid (e.g., water, brine, sea water, fresh water, or a well-treatment fluid (e.g., an acid, a fracturing fluid comprising polymers, produced water, sand, slickwater, etc.,)) prior to and/or during injection into the wellbore. In some embodiments, a composition for injecting into a wellbore is provided comprising a microemulsion as described herein and a dilution fluid (e.g., an aqueous carrier fluid), wherein the microemulsion is present in an amount between about 0.1 and about 50 gallons per thousand gallons (gpt) per dilution fluid, or between 0.1 and about 100 gpt, or between about 0.5 and about 10 gpt, or between about 0.5 and about 2 gpt. In certain embodiments, the microemulsion is present in a dilution fluid in an amount between about 0.1 wt % and about 50 wt %, or between about 0.01 wt % and about 50 wt %, or between about 0.01 wt % and about 25 wt %, or between about 0.01 wt % and about 10 wt %, or between about 0.1 wt % and about 10 wt %, or between about 0.1 wt % and about 5 wt %, or between about 0.01 wt % and about 5 wt %, or between about 0.1 wt % and about 2 wt %, of the dilution fluid.

In some embodiments, the addition of a dilution fluid does not alter the structure of the emulsion and/or microemulsion (e.g., after the addition of a dilution fluid, the emulsion and/or microemulsion includes a plurality of nanoparticles, non-aqueous phase in contact with the plurality of nanoparticles, and a surfactant encapsulating the nanoparticle and the non-aqueous phase). That is to say, the emulsion and/or microemulsion remains an emulsion and/or microemulsion after the addition of the dilution fluid. In some embodiments, an emulsion forms a microemulsion in the presence of a dilution fluid. In other embodiments, the average diameter of a microemulsion decreases or increases in the presence of a dilution fluid.

Dilution fluids may contain one or more additives, as described in more detail above. Non-limiting examples of additives present in the dilution fluid include an alcohol, a freezing point depression agent, an acid, a salt, a proppant, a scale inhibitor, a friction reducer, a biocide, a corrosion inhibitor, a buffer, a viscosifler, a clay swelling inhibitor, an oxygen scavenger, and/or a clay stabilizer.

The emulsions and microemulsions described herein may be used in various aspects of a life cycle of an oil and/or gas well, including, but not limited to, drilling, mud displacement, casing, cementing, perforating, stimulation, enhanced oil recovery/improved oil recovery, etc.). Inclusion of an emulsion or microemulsion into the fluids typically employed in these processes, for example, drilling fluids, mud displacement fluids, casing fluids, cementing fluids, perforating fluid, stimulation fluids, kill fluids, etc., results in many advantages as compared to use of the fluid alone.

For convenience, certain terms employed in the specification, examples, and appended claims are listed here.

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999, the entire contents of which are incorporated herein by reference.

Certain compounds of the present invention may exist in particular geometric or stereoisomeric forms. The present invention contemplates all such compounds, including cis- and trans-isomers, R- and S-enantiomers, diastereomers, (D)-isomers, isomers, the racemic mixtures thereof, and other mixtures thereof, as falling within the scope of the invention. Additional asymmetric carbon atoms may be present in a substituent such as an alkyl group. All such isomers, as well as mixtures thereof, are intended to be included in this invention.

Isomeric mixtures containing any of a variety of isomer ratios may be utilized in accordance with the present invention. For example, where only two isomers are combined, mixtures containing 50:50, 60:40, 70:30, 80:20, 90:10, 95:5, 96:4, 97:3, 98:2, 99:1, or 100:0 isomer ratios are all contemplated by the present invention. Those of ordinary skill in the art will readily appreciate that analogous ratios are contemplated for more complex isomer mixtures.

The term “aliphatic,” as used herein, includes both saturated and unsaturated, nonaromatic, straight chain (i.e. unbranched), branched, acyclic, and cyclic (i.e. carbocyclic) hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Thus, as used herein, the term “alkyl” includes straight, branched and cyclic alkyl groups. An analogous convention applies to other generic terms such as “alkenyl”, “alkynyl”, and the like. Furthermore, as used herein, the terms “alkyl”, “alkenyl”, “alkynyl”, and the like encompass both substituted and unsubstituted groups. In certain embodiments, as used herein, “aliphatic” is used to indicate those aliphatic groups (cyclic, acyclic, substituted, unsubstituted, branched or unbranched) having 1-20 carbon atoms. Aliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The term “alkane” is given its ordinary meaning in the art and refers to a saturated hydrocarbon molecule. The term “branched alkane” refers to an alkane that includes one or more branches, while the term “unbranched alkane” refers to an alkane that is straight-chained. The term “cyclic alkane” refers to an alkane that includes one or more ring structures, and may be optionally branched. The term “acyclic alkane” refers to an alkane that does not include any ring structures, and may be optionally branched.

The term “alkene” is given its ordinary meaning in the art and refers to an unsaturated hydrocarbon molecule that includes one or more carbon-carbon double bonds. The term “branched alkene” refers to an alkene that includes one or more branches, while the term “unbranched alkene” refers to an alkene that is straight-chained. The term “cyclic alkene” refers to an alkene that includes one or more ring structures, and may be optionally branched. The term “acyclic alkene” refers to an alkene that does not include any ring structures, and may be optionally branched.

The term “aromatic” is given its ordinary meaning in the art and refers to aromatic carbocyclic groups, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated pi electron system, while other, adjoining rings can be cycloalkyls, cycloalkenyls, cycloalkynyls, aryls and/or heterocyclyls.

The term “aryl” is given its ordinary meaning in the art and refers to aromatic carbocyclic groups, optionally substituted, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated pi electron system, while other, adjoining rings can be cycloalkyls, cycloalkenyls, cycloalkynyls, aryls and/or heterocyclyls. The aryl group may be optionally substituted, as described herein. Substituents include, but are not limited to, any of the previously mentioned substituents, i.e., the substituents recited for aliphatic moieties, or for other moieties as disclosed herein, resulting in the formation of a stable compound. In some cases, an aryl group is a stable mono- or polycyclic unsaturated moiety having preferably 3-14 carbon atoms, each of which may be substituted or unsubstituted.

These and other aspects of the present invention will be further appreciated upon consideration of the following Examples, which are intended to illustrate certain particular embodiments of the invention but are not intended to limit its scope, as defined by the claims.

### EXAMPLES

### Example 1

34 wt % of a dispersion of 12 nm hydrophobized silica in d-limonene was mixed with 16.25 wt % ethoxylated alcohol surfactant, 16.25 wt % isopropyl alcohol, and 34 wt % deionized water to form a transparent microemulsion. Such silica dispersions are commercially available (e.g., from Nissan Chemical or Evonik). This microemulsion was subsequently dispersed to 0.2 wt % in 2% KCl aqueous solution to form a transparent dispersion.

### Example 2

This example describes a non-limiting experiment for determining displacement of residual aqueous treatment fluid by formation crude oil. A 25 cm long, 2.5 cm diameter capped glass chromatography column was packed with 77 grams of 100 mesh sand or a mixture of 70/140 mesh shale and 100 mesh sand or a mixture of 70/140 mesh shale and 100 mesh sand. The column was left open on one end and a PTFE insert containing a recessed bottom, 3.2 mm diameter outlet, and nipple was placed into the other end. Prior to placing the insert into the column, a 3 cm diameter filter paper disc (Whatman, #40) was pressed firmly into the recessed bottom of the insert to prevent leakage of 100 mesh sand. A 2 inch piece of vinyl tubing was placed onto the nipple of the insert and a clamp was fixed in place on the tubing prior to packing. The columns were gravity-packed by pouring approximately 25 grams of the diluted microemulsions (e.g., the microemulsions described in Example 1, and diluted with 2% KCl, e.g., to about 2 gpt, or about 1 gpt) into the column followed by a slow, continuous addition of sand. After the last portion of sand had been added and was allowed to settle, the excess of brine was removed from the column so that the level of liquid exactly matched the level of sand. Pore volume in the packed column was calculated as the difference in mass of fluid prior to column packing and after the column had been packed. Three additional pore volumes of brine were passed through the column. After the last pore volume was passed, the level of brine was adjusted exactly to the level of sand bed. Light condensate oil was then added on the top of sand bed to form the 5 cm oil column above the bed. Additional oil was placed into a separatory funnel with a side arm open to an atmosphere. Once the setup was assembled, the clamp was released from the tubing, and timer was started. Throughout the experiment the level of oil was monitored and kept constant at a 5 cm mark above the bed. Oil was added from the separatory funnel as necessary, to ensure this constant level of head in the column. Portions of effluent coming from the column were collected into plastic beakers over a measured time intervals. The amount of fluid was monitored. When both brine and oil were produced from the column, they were separated with a syringe and weighed separately. The experiment was conducted for 3 hours at which the steady-state conditions were typically reached. The cumulative % or aqueous fluid displaced from the column over 120 minute time period, and the steady-state mass flow rate of oil at t=120 min through the column were determined.

### Example 2-1

The ability of the 0.2 wt % microemulsion dispersion to promote flowback of residual aqueous phase from a sand-pack was measured using a standard sand-pack column experiment, as described in Example 2. Briefly, the amount of aqueous treatment fluid in the sand-pack displaced by a 5 cm hydrostatic head of crude oil is measured as a function of time. The amount of residual aqueous phase comprising the 0.2 wt % dispersion of the nanosilica-in-d-limonene microemulsion displaced by the crude oil after 60 minutes was 78%.

### Comparative Example 2-2

A comparable microemulsion of d-limonene without any nanoparticles present was prepared using the same ethoxylated alcohol surfactant, deionized water and isopropyl alcohol with proportions of 27 wt % d-limonene, 23 wt % ethoxylated alcohol surfactant, 23 wt % IPA and 27 wt % deionized water. Similar studies were carried out as in Example 1 and Example 2 and the amount of residual aqueous phase displaced by crude oil after 60 minutes was 59% for this treatment.

### Comparative Example 2-3

27 wt % of a dispersion of 3-5 nm hydrophobized silica in d-limonene was mixed with 23 wt % ethoxylated alcohol surfactant, 23 wt % isopropyl alcohol and 27 wt % deionized water to form a transparent microemulsion. This microemulsion was subsequently dispersed to 0.2 wt % in 2% KCl aqueous solution to form a transparent dispersion. Similar studies were carried out as in Example 1 and Example 2 and the amount of residual aqueous phase comprising the 0.2 wt % dispersion of the nanosilica-in-d-limonene microemulsion displaced by the crude oil after 60 minutes was 60%.

### Example 3

27 wt % of a dispersion of 10-15 nm hydrophobized silica in toluene was mixed with 23 wt % ethoxylated alcohol surfactant, 23 wt % isopropyl alcohol and 27 wt % deionized water to form a transparent microemulsion. This microemulsion was subsequently dispersed to 0.2 wt % in 2% KCl aqueous solution to form a transparent dispersion. Similar studies were carried out as in Example 1 and Example 2 and the amount of residual aqueous phase comprising the 0.2 wt % dispersion of the nanosilica-in-toluene microemulsion displaced by the crude oil after 60 minutes was 63%.

### Comparative Example 3-1

A comparable microemulsion of toluene without any nanoparticles present was prepared using the same ethoxylated alcohol surfactant as Example 2, with 27 wt % d-limonene, 23 wt % ethoxylated alcohol surfactant, 23 wt % isopropyl alcohol and 27 wt % deionized water. Similar studies were carried out as in Example 2 and the amount of residual aqueous phase comprising the microemulsion displaced by crude oil after 60 minutes was 55%.

### Example 4

This example provides information regarding hydrophobized silica employed in the Examples. Nanosilica dispersed in various non-aqueous solvents including toluene, methyl ethyl ketone, methyl isobutyl ketone, N,N-dimethyl acetamide, ethylene glycol, IPA, ethylene glycol mono-n-propyl ether, propylene glycol mono-methyl ether acetate, ethyl acetate, xylene, n-butanol, methoxy propanol, and methanol may be purchased from commercial suppliers (e.g., from Nissan Chemical or Evonik).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e. elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e. the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element or a list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e. to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method for treating an oil and/or gas well comprising,
combining a first fluid and a second fluid to form an emulsion or a microemulsion,
wherein the first fluid comprises a plurality of hydrophobic nanoparticles and a non-aqueous phase;
wherein the second fluid comprises a surfactant and an aqueous phase; and
wherein in the microemulsion, a portion of the nanoparticles are each at least partially surrounded by surfactant and in contact with at least a portion of the non-aqueous phase; and
injecting the emulsion or microemulsion into an oil and/or gas well comprising a wellbore.

2. The method of claim 1, wherein the plurality of hydrophobic nanoparticles comprise a material selected from the group consisting of silica, titania, alumina, zirconia, vanadia, ceria, iron oxide, antimony oxide, tin oxide, aluminum, zinc oxide, boron, chromite spinel pigments, and silicone resin, or combinations thereof.

3. The method of claim 1, wherein the plurality of hydrophobic nanoparticles have an average diameter between about 5 nm and about 30 nm.

4. The method of claim 1, wherein the non-aqueous phase comprises d-limonene.

5. The method of claim 1, wherein at least a portion of each nanoparticle is not in contact with the non-aqueous phase.

6. The method of claim 1, wherein the surfactant comprises an ethoxylated alcohol.

7. The method of claim 1, wherein the surfactant comprises a first type of surfactant and a second type of surfactant.

8. The method of claim 1, wherein the second fluid comprises an alcohol.

9. The method of claim 8, wherein the alcohol is present in an amount between about 0 wt % and about 50 wt %, or between about 0.1 wt % and about 50 wt %, or between about 1 wt % and about 50 wt %, or between about 2 wt % and about 50 wt % or between about 5 wt % and about 40 wt %, or between about 5 wt % and 35 wt %, versus the total microemulsion composition.

10. The method of claim 8, wherein the alcohol is isopropyl alcohol.

11. The method of claim 1, wherein the microemulsion is diluted with a dilution fluid prior to injecting the microemulsion into an oil and/or gas well comprising a wellbore.

12. The method of claim 10, wherein the dilution fluid comprises a salt.

13. The method of claim 11, wherein the salt comprises KCl.

14. The method of claim 12, wherein the salt is present in an amount between about 0 wt % and about 5 wt %, or between about 0.5 and 5 wt %, or between about 1 wt % and about 5 wt %, or between about 2 wt % and about 5 wt %, or between about 3 wt % and about 5 wt %, or between about 1 wt % and about 3 wt %, or between about 0.1 wt % and about 2 wt %, of the dilution fluid.

15. The method of claim 11, wherein the dilution fluid comprises one or more additives.

16. The method of claim 15, wherein the one or more additives are selected from the group consisting of an alcohol, a freezing point depression agent, an acid, a salt, a proppant, a scale inhibitor, a friction reducer, a biocide, a corrosion inhibitor, a buffer, a viscosifier, a clay swelling inhibitor, an oxygen scavenger, and/or a clay stabilizer.

17. The method of claim 15, wherein the one or more additives are present in an amount between about 1 wt % and about 30 wt %, or between about 1 wt % and about 25 wt %, or between about 1 wt % and about 20 wt % of the dilution fluid.

18. The method of claim 11, wherein the microemulsion is present in the dilution fluid in an amount between about 0.1 wt % and about 50 wt %, or between about 0.01 wt % and about 50 wt %, or between about 0.01 wt % and about 25 wt %, or between about 0.01 wt % and about 10 wt %, or between about 0.1 wt % and about 10 wt %, or between about 0.1 wt % and about 5 wt %, or between about 0.01 wt % and about 5 wt %, or between about 0.1 wt % and about 2 wt %, of the dilution fluid.

19. The method of claim 1, wherein a portion of the nanoparticles are each at least partially encapsulated by surfactant.

20. The method of claim 1, wherein the microemulsion comprises between about 5 wt % to about 70 wt %, between about 10 wt % and about 50 wt %, or between about 15 wt % and about 30 wt % of the first fluid, versus the total microemulsion composition.

21. The method of claim 1, wherein the first fluid comprises between about 5 wt % and about 50% wt %, between about 10 wt % and about 40 wt %, or between about 15 wt % and about 30 wt % of the plurality of hydrophobic nanoparticles, versus the total first fluid composition.

22. The method of claim 1, wherein the aqueous phase comprises water.

23. The method of claim 22, wherein the total amount of water and/or the aqueous phase present in the microemulsion is between about 1 wt % about 95 wt %, or between about 1 wt % about 90 wt %, or between about 1 wt % and about 60 wt %, or between about 5 wt % and about 60 wt % or between about 10 and about 55 wt %, or between about 15 and about 45 wt %, versus the total microemulsion composition.

24. The method of claim 1, wherein the surfactant is present in an amount between about 0 wt % and about 99 wt %, or between about 1 wt % and about 90 wt %, or between about 0 wt % and about 60 wt %, or between about 1 wt % and about 60 wt %, or between about 5 wt % and about 60 wt %, or between about 10 wt % and about 60 wt %, or between about 5 wt % and about 65 wt %, or between about 5 wt % and about 55 wt %, or between about 10 wt % and about 55 wt %, or between about 2 wt % and about 50 wt %, or between about 0 wt % and about 40 wt %, or between about 15 wt % and about 55 wt %, or between about 20 wt % and about 50 wt %, versus the total microemulsion composition.
